(19) United States
(12) Patent Application Publication
(10) Pub. No.: US 2008/0061951 A1
(43) Pub. Date: Mar. 13, 2008

(54) Image transferrable anti-theft system

(76) Inventor: Tien Lun Liu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/512,286

(22) Filed: Aug. 30, 2006

(51) Int. Cl. B60R 25/10; H04N 7/18

(52) U.S. Cl. 340/426.15; 348/143

(57) ABSTRACT

An anti-theft system includes a carrier such as a vehicle and a camera is located in the space such as the driver cabinet of the carrier and is controlled by a controller. The camera can be activated when the entrance member is opened and a transferring device is electrically connected to the controller so as to transfer images videoed by the camera to a receiving device which can be a cellular phone, a computer or a PDA.

### FIELD OF THE INVENTION

The present invention relates to an anti-theft system for vehicles and the system includes a camera and a transferring device which transfers the image of the invader to a receiving device of the owner.

### BACKGROUND OF THE INVENTION

A conventional way to stop the thieves to steal the vehicles is to install an alarm device which can be activated when the doors of the vehicles are opened without authorization. However, the alarm device can also be activated by impact by even a pebble hitting on the vehicle or by vibration coming from the road. Once the vehicle is stolen, the owner has no way to know where his/her vehicle is. Besides, a latest method for stopping car from being stolen is to use a GPS device which provides accurate positioning feature of the vehicle. Usually, the stolen vehicles will be found in a remote area and the owners are not able to know anything of the thieves even the stolen vehicles are accurately positioned.

The present invention intends to provide a vehicle anti-theft system which includes a controller to activate a camera in the vehicle when un-authorized persons invade into the vehicle. The thief's image is then transferred to a receiving device of the owner or the police.

### SUMMARY OF THE INVENTION

The present invention relates to an anti-theft system that comprises a carrier such as a vehicle which has a space defined therein and a controller is connected to the carrier. The controller is electrically connected to a driving device such as the engine and an entrance member such as the doors of the carrier. A camera is located in the space of the carrier and controlled by the controller. The camera is activated when the entrance member is opened. A transferring device is electrically connected to the controller and transfers images videoed by the camera to a receiving device which controls the controller to activate the camera.

The primary object of the present invention is to provide an anti-theft system for vehicles, and comprises a camera to video the thief's image and the image can be transferred to the owner or the police.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the flow chart of the anti-theft system of the present invention;

FIG. 2 shows that the thief's image is transferred to the owner's cellular phone;

FIG. 3 shows the first way of the steps that the anti-theft system of the present invention works;

FIG. 4 shows the second way of the steps that the anti-theft system of the present invention works;

FIG. 5 shows that when the door of the vehicle is opened, the camera is activated and the image in the driver cabinet is sent to the owner's cellular phone;

FIG. 6 shows another embodiment of the flow chart of the anti-theft system of the present invention, and

FIG. 7 shows the embodiment in FIG. 6 is used in a truck with a cargo trailer.

### DETAILED DESCRIPTION OF THE PREFERRED EMBODIMENT

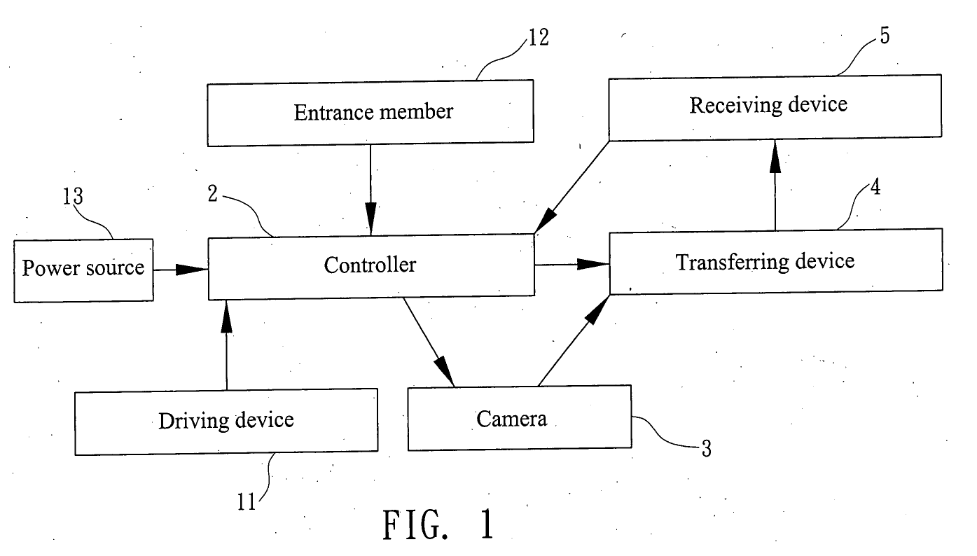

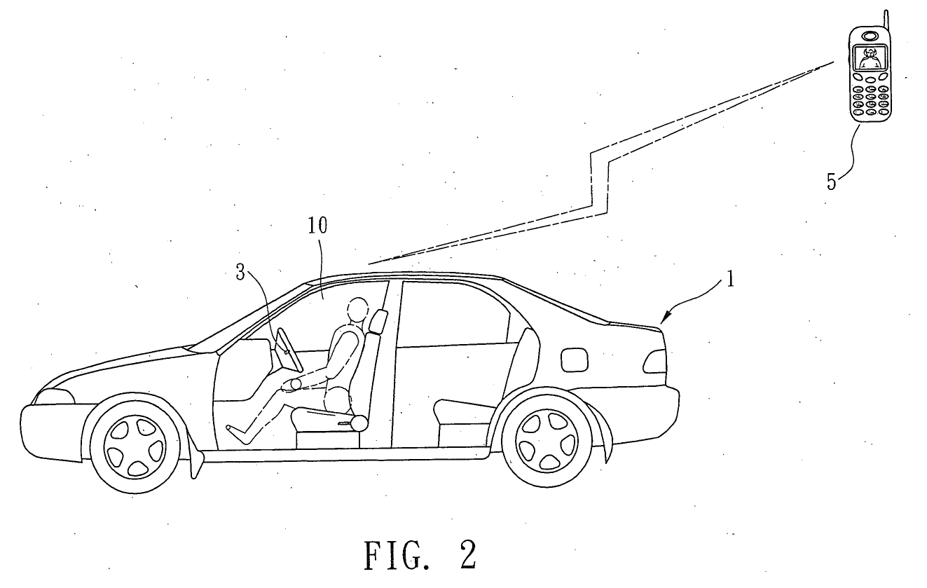

Referring to FIGS. 1 to 3, the anti-theft system of the present invention comprises a carrier 1 such as a vehicle which has a space 10 defined therein such as the driver cabinet. A controller 2 is connected to the carrier 1 and electrically connected to a driving device 11 such as the engine of the vehicle and four entrance members 12 such as the doors of the carrier 1. The controller 2 is powered by the power source 13 such as the battery of the carrier 1. A camera 3 such as a CCD camera is located in the space 10 of the carrier 1 and controlled by the controller 2. The camera 4 can be activated when one of the entrance members 12 is opened, and by the controller 2 which is operated by the owner of the carrier 1.

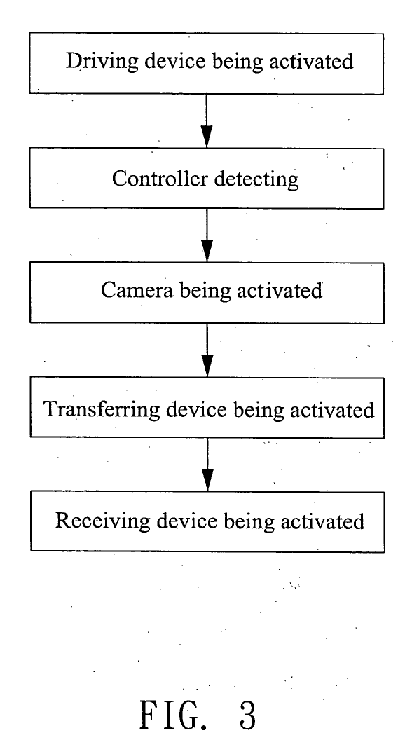

A transferring device 4 is electrically connected to the controller 2 and transfers images videoed by the camera 3 to a receiving device 5 which controls the controller 2 to activate the camera 3. The receiving device 5 can be a cellular phone, a computer such as a laptop, or a PDA. When a thief starts the engine of the vehicle without the owner's permission as shown in FIG. 3, the controller 2 detects the change of the engine and the camera 3 is activated to video the image of the thief. The image is then sent to the receiving device 5. Therefore, the owner of the vehicle is acknowledged what happens and the thief's face is seen and can be saved in the receiving device 5.

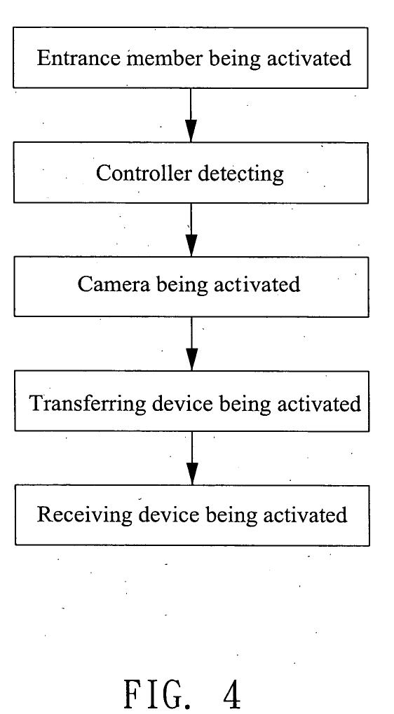

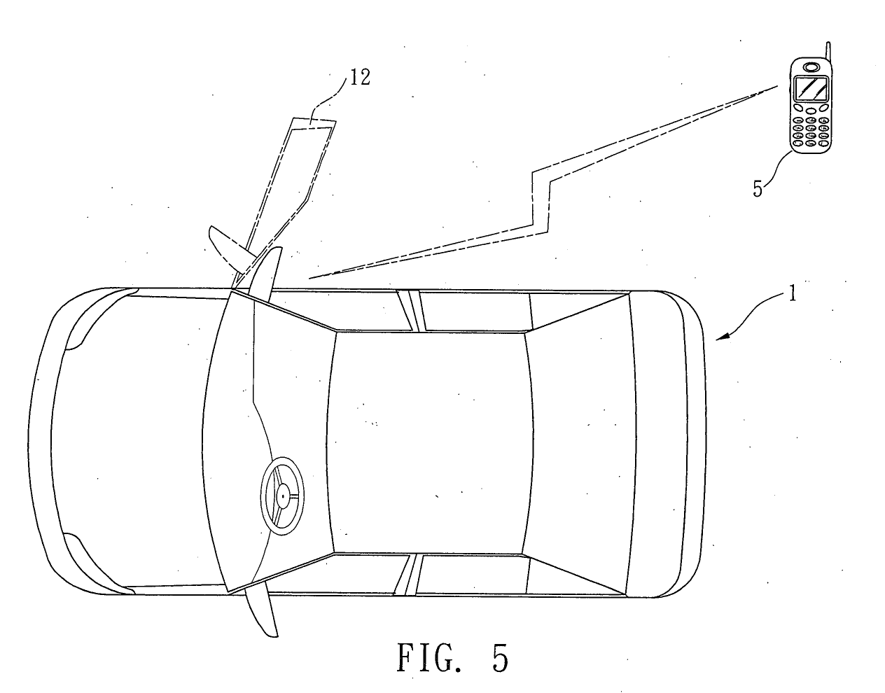

By the anti-theft system of the present invention, when an invader enters the vehicle without the owner's permission as shown in FIGS. 4 and 5, the controller 2 detects the invasion and the camera 3 is activated by the controller 2 and the image of the invader is then sent to the owner's cellular phone, computer such as a laptop, or PDA so that the owner knows what happens and sees the invader.

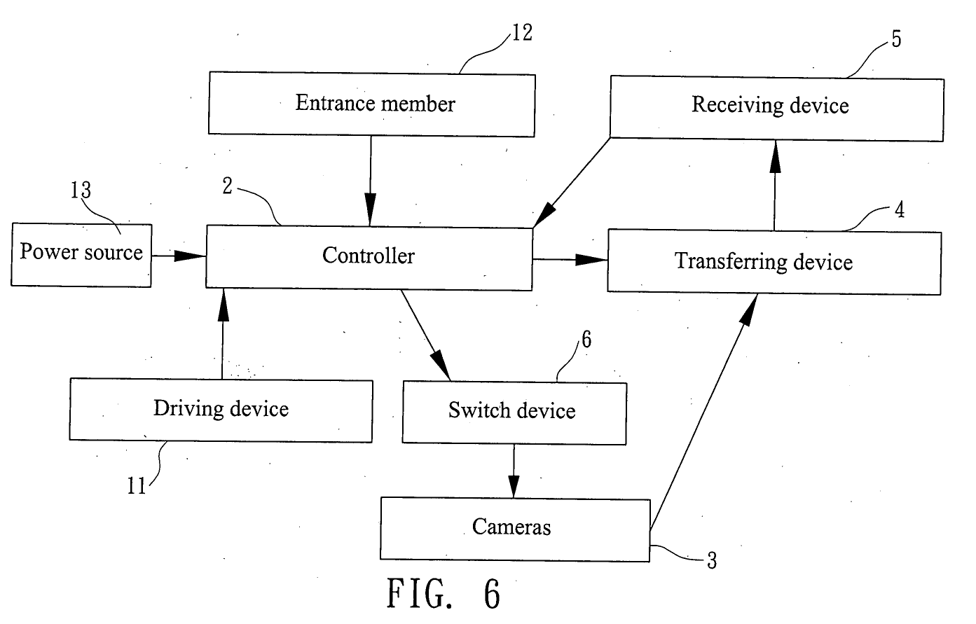

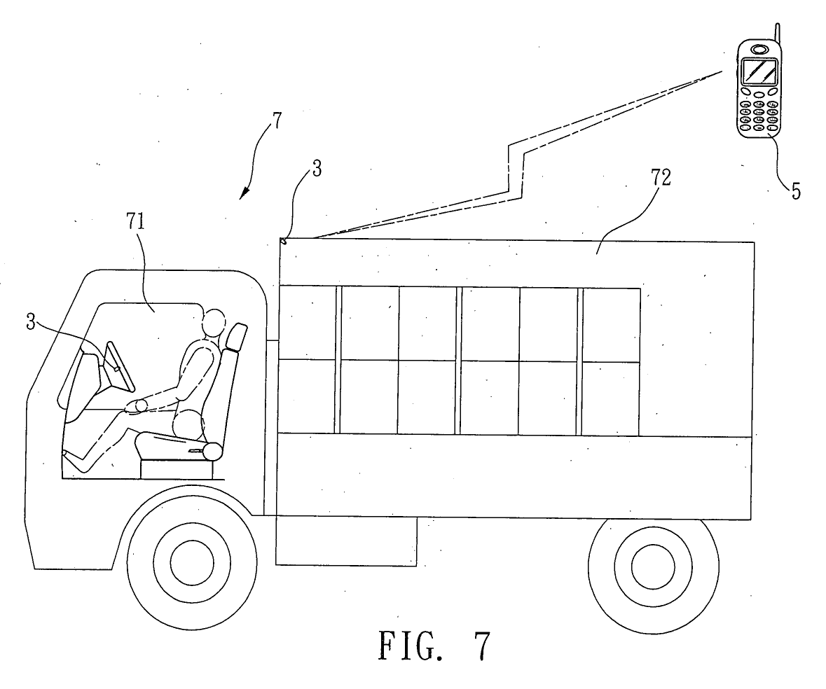

As shown in FIGS. 6 and 7, the anti-theft system of the present invention comprises at least two cameras 3 located in the driver cabinet and the cargo space in the trailer 72 of the carrier 7 such as a truck. A switch device 6 is driven by the controller 2 and activates the transferring device 4 to transfer the images from a chosen camera 3 to the receiving device 5.

It is noted that the transferring device 4 transfers the images by way of GSM, GPRS, bluetooth, far infra-red transferring or internet.

While we have shown and described the embodiment in accordance with the present invention, it should be clear to those skilled in the art that further embodiments may be made without departing from the scope of the present invention.

What is claimed is:

1. An anti-theft system comprising:
a carrier having a space defined therein;
a controller connected to the carrier and being electrically connected to a driving device and an entrance member of the carrier;
a camera located in the space of the carrier and being controlled by the controller and being activated when the entrance member is opened, and
a transferring device electrically connected to the controller and transferring images videoed by the camera to a receiving device which controls the controller to activate the camera.

2. The system as claimed in claim 1, wherein the camera is a CCD camera.

3. The system as claimed in claim 1, wherein the receiving device is one of a cellular phone, a computer such as a laptop, or a PDA.

4. The system as claimed in claim 1, wherein the transferring device transfers the images by way of GSM, GPRS, bluetooth, far infra-red transferring or internet.

5. The system as claimed in claim 1, wherein the driving device is an engine.

6. The system as claimed in claim 1, wherein the entrance member is a door.

7. The system as claimed in claim 1, wherein the controller is powered by a power source of the carrier.

8. The system as claimed in claim 1, wherein the space of the carrier is a driver cabinet.

9. The system as claimed in claim 1, wherein the space is in a cargo trailer of the carrier.

10. The system as claimed in claim 1, wherein a switch device is driven by the controller and activates the transferring device to transfer the images from a chosen camera to the receiving device.
